(19) United States
(12) Patent Application Publication
(10) Pub. No.: US 2005/0249914 A1
(43) Pub. Date: Nov. 10, 2005

(54) Honeycomb-shaped carbon element

(76) Inventors: Thorsten Scheibel, Bad Nauheim (DE); Roland Weiss, Huttenberg (DE); Martin Henrich, Wetzler (DE); Marco Ebert, Wetter (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/516,324

(22) PCT Filed: Jun. 11, 2003
(86) PCT No.: PCT/EP03/06123

§ 371 Date: Feb. 15, 2005

(30) Foreign Application Priority Data
Jun. 11, 2002 (DE) 102 25 953.4

(51) Int. Cl. B32B 3/12

(52) U.S. Cl. 428/116; 264/29.4

(57) ABSTRACT

A method for producing a carbon element having a honeycomb-shaped structure by utilizing a prefabricated element that is made of paper or fleece and provided with a honeycomb-shaped structure. The prefabricated element is pyrolyzed and stabilized.

The invention relates to a method for producing a carbon element having a honeycomb-shaped structure.

Corresponding elements with a honeycomb structure have the advantage of being very stiff while having a low weight. In order to produce corresponding honeycomb structures from carbon material U.S. Pat. No. 5,567,500 suggests the use of several layers of fiber material with fibers extending in deviating directions, wherein between corresponding layers the cores specifying the honeycomb geometry are arranged, whereupon the layers are cured by exposing them to heat, while binding between them occurs at the same time. For this purpose the layers are impregnated with resin. The layers are in particular fabrics or prepregs.

The complex manufacturing method for designing the honeycomb structures is tolerated in order to obtain sandwich elements or plates, which are used especially in airplanes and which are extremely stable while having a low weight.

Also honeycomb-shaped elements that are made of Aramid paper (NOMEX®) or aluminum are available.

In U.S. Pat. No. 4,518,704 an element having a honeycomb structure is described, which is made from activated carbon. For this purpose a mixture containing the activated carbon is extruded, the formed body is then dried and finally pyrolyzed.

In a method for producing porous fiber components according to DE 43 01 396 C2, fiber fabrics are made from endless fibers, placed on top of each other in at least two layers and then bonded with each other.

According to JP 57027130 and JP 11217278 A, porous bodies or honeycomb elements are made from activated carbon. Here the bodies are dried and pyrolized after forming.

It is the object of the present invention to make a carbon element having a honeycomb structure available that is easy to produce, has high mechanical stability and whose material properties can be adjusted as needed.

To achieve this object the use of a prefabricated base body that is made from resin-impregnated paper or fleece and has a honeycomb structure is suggested, wherein the base body is first pyrolyzed and then stabilized and/or compressed.

Deviating from the prior art, a prefabricated base body that already has a honeycomb structure is used in the manufacture of the carbon element, said base body comprising sufficient material that can be converted into carbon so that the layered arrangement of carbon fabrics or prepregs, which is required pursuant to the state of the art, is not necessary.

In other words, a commercially obtainable and as such available honeycomb element is used to produce a honeycomb element made from carbon by means of pyrolysis and stabilization, which can be planked e.g. with boards to be used then as a sandwich component in the aviation and aerospace industry. In particular, however, a correspondingly produced carbon body having a honeycomb structure can be used in the chemical industry e.g. as catalyst or filter.

In particular it is provided that a honeycomb element made from resin-impregnated Aramid paper is used as the base body. Independent from this the pyrolyzed base body can be stabilized or compressed by means of material precipitation from the gaseous phase. In a preferred embodiment it is provided that the pyrolyzed base body be stabilized or compressed especially by means of CVI (Chemical Vapor Infiltration) and/or CVD (Chemical Vapor Deposition) precipitation with C, SiC, B₄C and/or Si.

Furthermore it is suggested that the prefabricated base body be carbonized at a temperature T₁ of 850° C.≦T₁≦1100° C., especially 900° C.≦T₁≦1000° C. It is also possible to graphitize the base body at a temperature T₂ wherein 1700° C.≦T₂≦3100° C., especially 1800° C.≦T₂≦2450° C.

The prefabricated base body consists at least of a resin as well as a reinforcing agent that specifies the honeycomb structure. The resin can be epoxies with a high carbon yield, thermoplastics such as PEEK, PI, phenolic resins, furan resins, epoxy novalak resins or other binding systems, which exhibit and guarantee adhesion or dimensional stability during and after pyrolysis.

The prefabricated base body made from paper or fleece having a honeycomb structure should comprise high-temperature stable fibers such as carbon fibers or SiC fibers or pyrolyzable fibers with satisfactory or sufficiently high carbon residue content. This includes for example phenolic resin fibers, Aramid fibers, flax, hemp or other natural fibers.

Preferably, however, a prefabricated honeycomb element that consists e.g. from Aramid paper saturated with a resin such as phenolic resin can be used. Corresponding honeycomb elements can be obtained from Dupont de Nemours. They are offered under the term NOMEX®.

Furthermore the invention provides that the pyrolyzed carbon element having the honeycomb structure, and stabilization, be subsequently treated or finished. This can likewise be possible by means of surface techniques such as CVI techniques (Chemical Vapor Infiltration), CVD methods (Chemical Vapor Deposition), pitch coating or treatment with carbon-containing solutions such as resins, epoxy resins, phenolic resins and subsequent conversion into carbon. Also subsequent treatment with ceramic slip is possible, which is converted into ceramics such as SiC.

In particular it is provided that an SiC surface layer is formed by siliconizing. For this, the carbon element can be treated with CVD or CVI processes in order to develop SiC or PyC (pyrographite layers). Also coating with liquid pitch or polymers is possible. Carbon bodies coated this way are then carbonized or graphitized.

Corresponding carbon elements having a honeycomb structure are determined especially for sandwich components or panels, which are used for example in the aviation and aerospace industry. Their use however is also conceivable in the high temperature range, as support structure for catalyst and filter applications, packing for reactor and chemical system manufacture, highly permeable support structures for high temperature applications while using corrosive media, mass transfer packages for chemical plants, packing in desorption columns for water treatment, packaging in absorption columns for emission treatment, fluid and gas distributors, insulating materials for thermal applications or resistance heating elements for example for process gas heating.

The honeycomb structure as such can be hexagonal in the usual fashion. Other geometries such as circles or squares, however, are also conceivable.

Typical dimensions of a carbon element having a honeycomb structure that is produced pursuant to the invention are: Board size 900 mm×600 mm with a honeycomb height of 40 mm. The honeycombs can have a hexagonal structure with typical cell widths of 7 mm×4 mm and a wall thickness of typically 0.2 mm.

The invention will be explained in more detail in the following based on an exemplary embodiment. Further details, benefits and features of the invention result from said embodiment and the claims—either alone and/or in combination.

In order to use a honeycomb element consisting of carbon with a hexagonal structure for use in a load-bearing sandwich board, initially a NOMEX® honeycomb of the ECA4.8-48 type was pyrolyzed under protective gas. The pyrolysis was performed at temperatures in the range from 800° C. to 1050° C. The resulting very brittle carbon honeycomb structure is then stabilized by means of CVI methods with PyC (pyrocarbon) precipitation. The process occurs at a temperature of about 1250° C. and takes about 60 hours.

The carbon honeycomb board produced this way has good compression strength values. In order to increase the mechanical properties further, the carbon honeycomb board was subjected to a resin impregnation process using phenolic resin and subsequent recarbonization at temperatures in the range from 950° C. to 1050° C. To increase the mechanical properties even further, the impregnation and recarbonization operations were repeated another two times. Subsequently a prefabricated CFC board (carbon fiber reinforced carbon plate) (about 2 mm thick) was applied onto the surfaces, i.e. the end faces of the honeycombs, respectively, of a correspondingly produced carbon honeycomb board with phenolic resin adhesive by means of a hot press while applying pressure (about 2 bar) and heat (about 140° C.). The CFC sandwich board created this way was subsequently subjected to carbonization at about 1000° C. in order to convert the phenolic resin film forming the adhesive into carbon.

This way a highly rigid CFC sandwich board was produced, which can be used as support structure in high temperature furnace construction.

1. Method for producing a carbon element having a honeycomb-shaped structure, using a resin-impregnated base body with a honeycomb-shaped structure that is made from paper or fleece, which is first pyrolyzed and then stabilized and/or compressed, characterized in that the stabilized honeycomb-shaped element is coated with a carbon-containing solution and then again pyrolyzed.

2. Method pursuant to claim 1, characterized in that a honeycomb element made from resin-impregnated Aramid paper is used as the base body.

3. Method pursuant to claim 1, characterized in that the pyrolyzed base body is stabilized and/or compressed by means of material precipitation from the gaseous phase.

4. Method pursuant to claim 3, characterized in that the pyrolyzed base body is stabilized and/or compressed in particular by means of CVI and/or CVD precipitation with C, SiC, B₄C and/or Si.

5. Method pursuant to claim 1, characterized in that an SiC or PyC layer is formed on the pyrolyzed base body.

6. Method pursuant to claim 1, characterized in that the pyrolyzed and stabilized or compressed base body is coated with a ceramic slip, which is converted into ceramics such as SiC.

7. Method pursuant to claim 1, characterized in that the base body having the honeycomb structure is carbonized at a temperature T1 wherein 850° C.≦T₁≦1100° C., especially 900° C.≦T₁≦1000° C.

8. Method pursuant to claim 1, characterized in that the base body is graphitized at a temperature T₂ wherein 1700° C.≦T₂≦3100° C., especially 1800° C.≦T₂≦2450° C.

9. Method pursuant to claim 1, characterized in that as the base body a body is used that comprises high temperature stable fibers such as carbon fibers or SiC fibers or pyrolyzable fibers with sufficient carbon residue such as phenolic resin fibers, Aramid fibers, flax, hemp or other cellulose fibers as the reinforcing material.

10. Method pursuant claim 1, characterized in that the pyrolyzed and stabilized or compressed base body is subsequently subjected to further strengthening or finishing operations.

11. Method pursuant claim 1, characterized in that the pyrolyzed and stabilized or compressed base body is siliconized.

12. (canceled)

13. A filter, catalyst or component that is to be planked for the aviation and aerospace industry comprising a honeycomb element made from Aramid paper, which is saturated with a resin, pyrolyzed and then stabilized and/or compressed.
